(19) United States
(12) Patent Application Publication
(10) Pub. No.: US 2017/0051522 A1
(43) Pub. Date: Feb. 23, 2017

(54) CONCRETE AND MASONRY RESTORATION AND ORNAMENTATION METHOD AND APPARATUS

(71) Applicant: Donald Velazquez, San Diego, CA (US)

(72) Inventor: Donald Velazquez, San Diego, CA (US)

(21) Appl. No.: 15/243,794

(22) Filed: Aug. 22, 2016

Related U.S. Application Data
(60) Provisional application No. 62/208,469, filed on Aug. 21, 2015.

(51) Int. Cl. E04G 23/02; G05B 19/402

(52) U.S. Cl. CPC E04G 23/0288; E04G 23/0296; E04G 23/0285; G05B 19/402; G05B 2219/45102

(57) ABSTRACT

A method for restoration of concrete and cementitious surfaces is provided which employs the determined positions of existing fissures in a concrete surface, along with channels to be formed into the concrete surface, to form an image or indicia in the concrete surface such as stone and grout lines. Either a manually drawn platform with a channel forming tool can be employed to move the tool along a pathway to form the channels, or a self-propelled platform may be employed which is computer controlled to form the channels in the proper determined positions to yield the image in combination with the original fissures which are filled during the operation.

### FIELD OF THE INVENTION

This application claims priority to U.S. Provisional Patent Application Ser. No. 62/208,469, filed on Aug. 21, 2016, which is incorporated herein in its entirety by this reference thereto.

The present subject matter relates to ornamentation, repair, and restoration of masonry bodies including concrete and tile. More particularly it relates to a method and apparatus for imparting recesses or scoring cementitious surfaces to form designs therein to decorate new and existing surfaces and to rehabilitate existing cracked surfaces to render them more aesthetic.

### PRIOR ART

Masonry bodies include such objects as house walls, driveways, patios, swimming pool walls, fountains, walkways, highways, and tilt-up construction. These bodies generally include concrete and other cementitious surfaces. Concrete bodies are subject to cracking, as for example due to settling of ground beneath the bodies. Such cracks may have a depth of inches. Further, such cracks are unsightly and are hazardous to people walking on the concrete. Simply filling such cracks by patching concrete leaves the appearance of a patched surface with seams of filled concrete or silicone or the like, being highly visible as if an advertisement that a crack was present and has been patched.

Overlay repairs intended to emulate set-stones may not provide a flat surface, and they may provide the same chance of tripping, breaking heels, and stubbing toes that occurs with many natural stone surfaces. Ornamental restoration may be done using stamp overlay products intended to place a layer to cover repaired or previously cracked surfaces. The objective of prior art methods, which is often unsuccessful, is to eliminate cracks or patterns. However, such prior art methods do not include the integration or use of existing cracks as a portion of the ornamentation while creating the appearance of patterns in the body or surface. Further, such prior art methods and devices, do not allow for the pre planning of a decorative surface using existing cracks as part of an overall design imparted to the concrete surface.

Many conditions can lead to exacerbation of concrete faults. Weeds or more sturdy vegetation tend to begin growing in cracks. The roots become well entrenched. This gives the property a dilapidated look. Growth of the vegetation tends to induce further cracks. In northern climates, snow will melt into cracks, leaving water in the crack. When the temperature drops, the water expands as it turns into ice, further stressing cracks. Further deterioration of the concrete body commonly results.

Many products exist for use in crack repair methods and concrete resurfacing. These products include Super-Krete® and Quik-Crete® concrete mixes. Such products are intended to provide for mechanical integrity of a concrete body. They are not intended for making the repaired surface look like anything other than a repaired surface. Overlay products are intended for ornamentation and can be stamped or textured. These products can be applied in varying thickness from about 1/16″ to ½″ or thicker, with ¼″ being common.

However, prior art methods are not focused on creating ornamentation in combination with repair and restoration to render the repaired surface to appear as planned or original. In many applications, it is highly undesirable to provide the appearance of a repaired surface which while appearing repaired, also is viewable as decorative and quite possibly original. For example, a very important quality of a house for sale is “curb appeal,” i.e., how attractive the property looks as a sales prospect drives up. Flaws in the appearance of the driveway tend to decrease the price and the value of the property. Complete replacement of the driveway, as a practical matter, is not cost justified.

Prior art techniques include creating the appearance of grout-like joints or actual grout joints. Workers may be required to be constantly bent over during certain operations, which can cause orthopedic problems as well as exhaustion and dehydration. There are power tools that allow a worker to stand. However, certain finishing operations still require a worker to bend over to work at ground level. Techniques generally require tools that operate at high speed and which provide a greater risk of injury to workers who are placed near the tools by this bent or stooped work requirement. Further, such risk causes higher insurance costs for contractors. However, prior art techniques which teach repair or decoration of cementitious and stone surfaces and the like, each have particular shortcomings.

United States Published Patent Application No. 20140272250 discloses a slab of building material in which a fill component is placed in a void. The slab may comprise a first body that is adhered to another body. The bodies may be comprised of natural stone, wood, or other material. This disclosure is directed toward making a new slab out of broken pieces of other slabs. It is not a method or device for repair cracks in a cementitious surface nor is it is not directed to repair and remediation in a manner rendering the slab aesthetically pleasing.

United States Published Patent Application No. 20150191398 discloses a method for forming patterns on a surface of a hydraulic binder composition with a stencil. After setting of the surface and removal of the stencil, a friable delayed concrete layer in the pattern of the stencil remains. The deposited surface is later washed away to leave a pattern in concrete. Although this method provides for forming a pattern, this method does not allow for remediation of the unfinished appearance of repaired or broken surfaces. The pattern is not coordinated with preexisting lines, e.g., cracks, in a surface and the secondary layer imparted to the original is prone to chipping or delaminating.

United States Published Patent Application No. 20140248460 discloses a method for concrete crack repair in which a saw cut is made next to an open shrinkage crack. Expansive mortar is placed in the saw cut. As the mortar sets, it expands. The expanded mortar shifts the saw cut toward the shrinkage crack to make the crack narrower. However, the crack is not treated and does not become part of a remediation solution.

U.S. Pat. No. 5,310,780 discloses compositions for staining concrete. These compositions are useful in coloring different bounded areas within a pattern. However, a process for making a pattern is not disclosed. United States Published Patent Application No. 20040151950 discloses a method in which stains are applied to different sections of a concrete test slab however no means for forming a decorative pattern is disclosed.

As such, there exists an unmet need, for a system for a method and apparatus for the repair of cracked concrete, stone, tile and other surfaces. Such a system should employ methods for engraving or imparting recessed patterns to the concrete or stone surface, which employs existing cracks to form a final viewable surface which disguises the existing cracks and imperfections to appear as part of a planned or original surface. Such a system should employ a device which imparts engraving or recesses into the surface being repaired, wherein the user is either upright and at a safe distance from the tool, or where the tool is engaged with a robotically moved mount, which employs electronic navigation within the defined borders of the area to be repaired, to impart patterns into the surface being repaired. Employing this robotic or remote controlled mount for the tool employed for surfacing, such a system can allow the user to impart virtually any pattern into a new surface or surface being repaired, to thereby place virtually any image into the surface. Still further, such a device enabling the method herein, should be easily operated either manually, or by remote control, to thereby allow widespread use by both homeowners and contractors to impart designs into both new surfaces and old surfaces being repaired.

It should be noted, the forgoing examples of related art and limitations related therewith are intended to be illustrative and not exclusive, and they do not imply any limitations on the exercise device and method described and claimed herein. Various limitations of the related art are already known or will become apparent to those skilled in the art upon a reading and understanding of the specification below and the accompanying drawings.

An object of the present invention is the provision of a system enabling the etching or engraving of concrete, stone, and similar surfaces, to impart indicia in the form of designs and images thereto.

It is another object of the invention to provide such a system for imparting designs into surfaces which allows for imparting designs to new surfaces of virtually any choice of design, and imparts designs to surfaces being repaired, which employs existing cracks and imperfections as part of the finished design.

Further objectives of this exercise invention will be brought out in the following parts of the specification wherein the summary and detailed description of the invention are for the purpose of fully disclosing the invention without placing limitations thereon.

### SUMMARY OF THE INVENTION

Briefly stated, in accordance with the present subject matter, a method and apparatus are provided to rehabilitate and beautify new and cracked concrete surfaces, in a cost-effective and sustainable way, minimizing the resources utilized in forming a replaced surface and obviating the need to remove and replace a concrete body. The apparatus enabling the method herein, includes a powered cutting tool for forming channels or recesses in the new or repaired surface, such as by routing, scoring, or cutting. Such powered cutting tools as herein defined, may include drills, rotary hammers, impact drills, jack hammers, grinders, oscillating tools, vibrators, routers, saws, granite cutters, concrete engraving tools and more. The selection of tool is made in accordance with the desired appearance of a finished product.

The tool is supported to a movable platform. The movable platform can have wheels, glides, or casters to allow movement. The platform may be self-propelled and autonomous and move according to an electronic map held in computer memory, or a handle may be supported to the platform at a selectable height to enable a worker to stand up straight while operating the tool. Smaller versions with or without wheels may be used on vertical surfaces.

In use, a cracked concrete surface is evaluated and a desired remediation is selected using either electronic imaging of the surface and its perimeter area, or rendering a drawing of the surface to be repaired. The remediation comprises forming a pattern into the surface to be repaired, which includes the cracks in the concrete or stone or other surface, as part of the finished image or design formed into the repaired surface.

To that end, “Grout lines” or recesses, are formed in the concrete in accordance with the pattern determined either using the self-propelled autonomous platform where it follows and electronic map of the surface to impart them, or by hand using a stencil or other guide placed on the surface to be repaired. These recesses can vary in depth, width, and length in accordance with the design of the chosen pattern of the image to be imparted to the surface being repaired or to a new surface.

One available image or pattern can impart the recesses to form a masonry surface appearing to have stones set individually. However, the system using the automated mode, can impart virtually any image into the surface being repaired or decorated. A substantially flat finished or repaired surface may be provided by the formation of the recesses into the surface which are slight, but still noticeable to the human eye when viewed.

Forms of masonry on which the recesses of the system herein can be used include driveways, sidewalks, walkways, patios, sidewalls, floors, entries, foyers and much more. The system herein however allows such repairs to be accomplished in a more cost-effective and ‘sustainable’ way, because rather than jack hammering and removing the surface, the existing cracks and imperfections may be employed as part of a finished pattern, image, or design, or they may be employed along with a random, natural-appearing pattern that allow a user to ‘hide the problem in plain sight’ and turn defects into art.

### BRIEF DESCRIPTION OF THE DRAWINGS

The accompanying drawings, which are incorporated herein and form a part of the specification, illustrate some, but not the only or exclusive examples of embodiments and/or features of the invention. It is intended that the embodiments and figures disclosed herein are to be considered illustrative, rather than limiting.

In the drawings:

FIG. 1 is a detailed perspective view of a crack in a concrete body, such as a driveway.

FIG. 2 is a perspective view of a cracked driveway.

FIG. 3 is a perspective view of a pattern incorporating the cracks in the driveway.

FIG. 4 shows a depiction of a surface being leveled and repaired with filler.

FIG. 5 shows a fissure which has been filled and ready for overlay or placement of adjacent channels.

FIG. 6 depicts a sectional view showing a filled fissure and overlay material.

FIG. 7 depicts a distal end of an engraving tool forming a channel in the surface.

FIG. 8 depicts a mount used herein with a tool powering an engraving tool.

FIG. 9 shows the mount of FIG. 8 but having a biasing component.

FIG. 10 shows a manually operated platform used in combination with the mount engaged with the power tool.

FIG. 11 shows a graphic plot or depiction of the perimeter of an existing surface with the existing fissures in the surface.

FIG. 12 depicts a guide which is determined from the image of FIG. 11, and which may be imparted to the surface, or used by a powered platform with electronic memory, to impart the channels to the surface.

FIG. 13 shows a powered platform which has the a mount thereon in operative engagement with a powered tool, and which can move robotically to impart the channels in the surface.

### DETAILED DESCRIPTION OF THE PREFERRED EMBODIMENTS OF THE INVENTION

In this description, any directional prepositions if employed, such as up, upwardly, down, downwardly, front, back, first, second, top, upper, bottom, lower, left, right and other such terms refer to the device or depictions as such may be oriented are describing such as it appears in the drawings and are used for convenience only. Such terms of direction and location are not intended to be limiting or to imply that the device herein has to be used or positioned in any particular orientation.

Now referring to drawings in figures herein, wherein similar components are identified by like reference numerals, the present subject matter relates to a method, process, and system to remediate and/or beautify cracked concrete surfaces, in a cost-effective and sustainable way, minimizing the resources utilized to provide a replaced surface and obviate the need to replace a concrete body. This technique can create a genuine or more natural rough edge than most manufactured products. In the method herein, recesses and lines are formed in the concrete to form an image or pattern thereupon, and in doing so, to incorporate cracks into a pattern.

The recesses may form patters or lines and all can vary in depth, width and length, depending on the desired image or pattern to be imparted to the surface, as well as the budget for such surfacing. Using either the manual or automated device herein to employ the method herein disclosed, skilled and even semi-skilled users can make masonry surfaces appear as stones set individually. Using the automated system herein employing the self-propelled platform which is autonomous and will move the platform and mount, according to an electronic map held in electronic memory, the tool employed can impart virtually any image or design into any horizontal or vertical surface.

The self-propelled system herein for imparting recesses and lines into the surface can accomplish such in a matter of hours using onboard computer memory and software running therein configured to steer the platform and if needed translate the mount to form the pattern in the driveway which has been predetermined as shown in FIGS. 11 and 12 for example. A skilled operator using the manual system such as in FIG. 6, can transform an average-size driveway or patio within a day, while comfortably standing, holding onto handlebars with little exertion. Masonry work can be done in a manner that is safer than prior art methods. Tools that operate at relatively low speed can be employed, or at high speed when the autonomous self-propelled platform is forming the image or pattern.

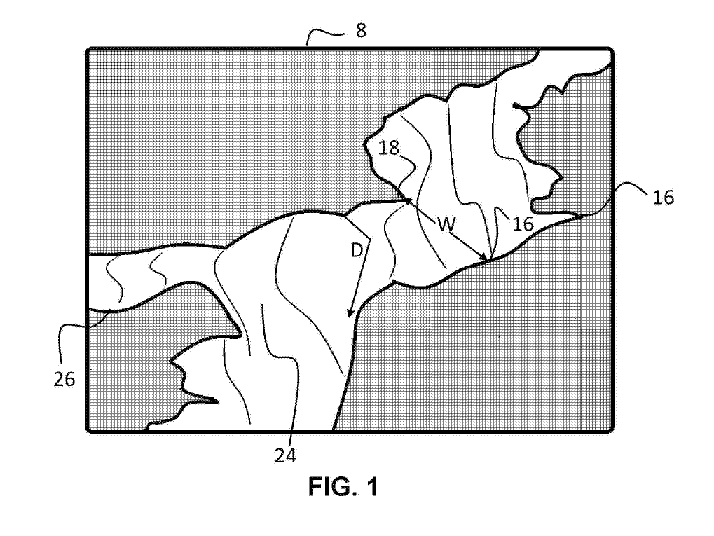

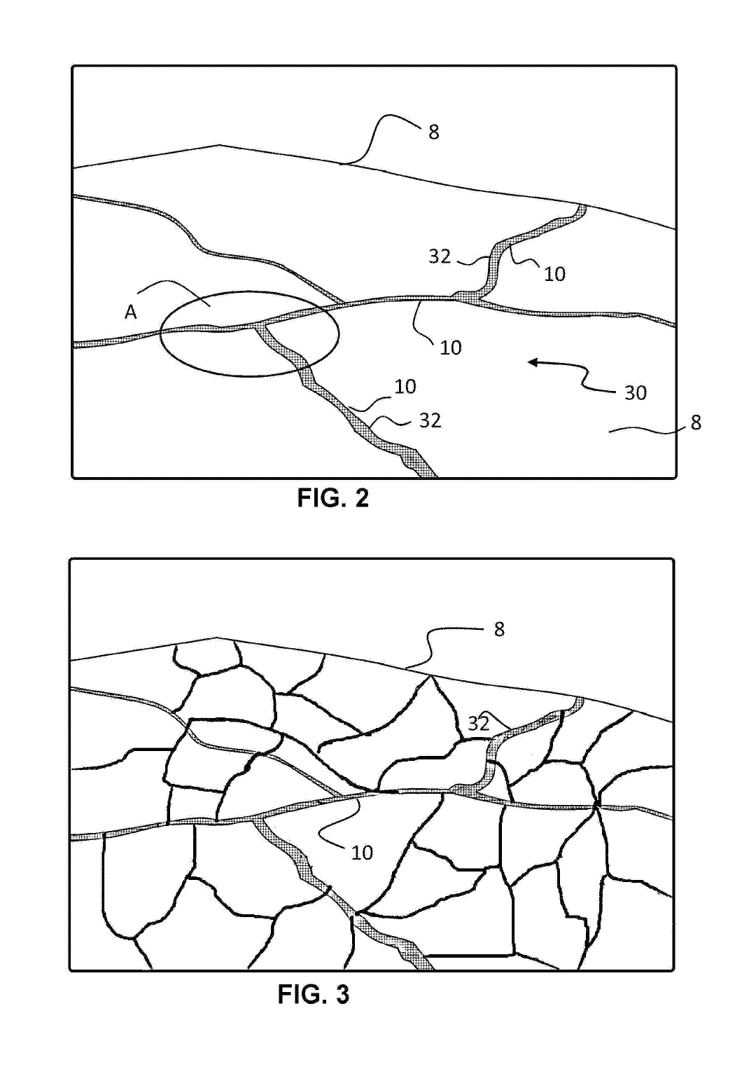

FIG. 1 depicts a detailed perspective view of a crack 11 in a concrete body such as a driveway, and more particularly a perspective view of an area A of FIG. 2. The crack 11 is positioned in the concrete body 4 such as a driveway 8. The crack 11 comprises one or more fissures 10 depending into and through an upper surface 12 of the concrete body 4.

At any particular position 14 along each crack 11, it has a width W the distance between opposite sides 16 and 18. Each crack 11 forming a fissure has a depth D. The depth D corresponds to the height of a fissure sidewall 24. Such fissure sidewalls 24 are usually irregular and may be disposed at any one of a number of angles with respect to a vertical axis at different positions along the length D. The intersection of the upper surface 12 and such a sidewall 24 is referred to as a corner 26. The term corner as used herein is used for convenience in description. In virtually all cases, the corner 26 will be a rounded rough edge rather than an intersection of planes.

FIG. 2 is a perspective view of a cracked driveway 8. A plurality or group 30 of fissures 10 formed from cracks, may be the result of settling of ground beneath the driveway 8 or any of a number of other causes. In prior art techniques, such fissures 10 may simply be filled with patching concrete 32. However, such is less than aesthetically pleasing since even with the fissures 10 filled, the driveway 8 appears damaged and simply patched, and the patching in this fashion simply advertises to viewers that this driveway was cracked in the past and a repair has been attempted.

As can be discerned, this prior art method of repair does virtually nothing to improve curb appeal or value of a property. The visual redundancy of cracks running through the concrete and the discolored repairs, makes the cracks particularly noticeable to the naked eye.

FIG. 3 is a perspective view illustrating the driveway 8 which has been repaired using the method and device herein in either the manual mode or automatic mode. In accordance with the present subject matter, the original group 30 of fissures is employed as the basis for providing an improved and ornamented appearing driveway. As shown in FIG. 2 and FIG. 8, using the method and device herein, a simulated set stone arrangement is created on the driveway surface. This is a preferred and desirable style in the context of masonry where such is positioned on real estate, and real estate improvements. Other forms of driveway finish, such as a composition of planar colored shapes may be provided in further embodiments.

As shown, in all modes of the system herein, the group 30 is used as the basis for a design of a pattern for formation into the surface. By this employment of the group 30 of fissures 10 to incorporate them in a pattern 40, the original fissures 10 are visually transformed from an eyesore to part of a design. The pattern 40 extending from and around the original group 30 of fissures, is formed of lines 44 laid out to simulate borders of set stone. The lines 44 define individual areas 46 bounded by lines 44 which as depicted simulate a stone surface, however in the automated mode of FIGS. 11-12, the lines 44 may depict any indicia which can be formed by continuous or interrupted lines 44.

In the method herein employing the device shown, the guide 229 may be formed by lines 44 may be imparted to the surface in any of a number of ways and provide a path for the user to follow with the tool. In one mode of the method herein, the lines may be drawn or otherwise temporarily formed such as with tape, onto the surface. Faintly depicted or inscribed lines will be sufficient to allow further process steps using the manual mode of the method herein and the device as in FIG. 6. If more precision is desired in forming the areas 46 from lines 44 or divots, or dots, a grid pattern 50 may be determined and included in a guide map 52 to allow an installer to determine and manually mark significant points along the lines 44. It should be noted that by the term lines 44 is meant any formed detent or recess into the surface being repaired, and it may simply be a dot, or short or curved line, or any recessed area formed into the surface during the imparting of indicia thereto. Such indicia may simply be a pattern of lines 44 to form the appearance of a stone surface, or it could be a pattern of detents, dots, all being lines 44 to form a figure, depiction of a photo, or virtually any indicia which can be employed to use the original cracks and fissures in the surface as part of the final image. For indicia not imparted for repair, any image which can be imparted using the channels 144 as defined herein, can be placed on the surface 12.

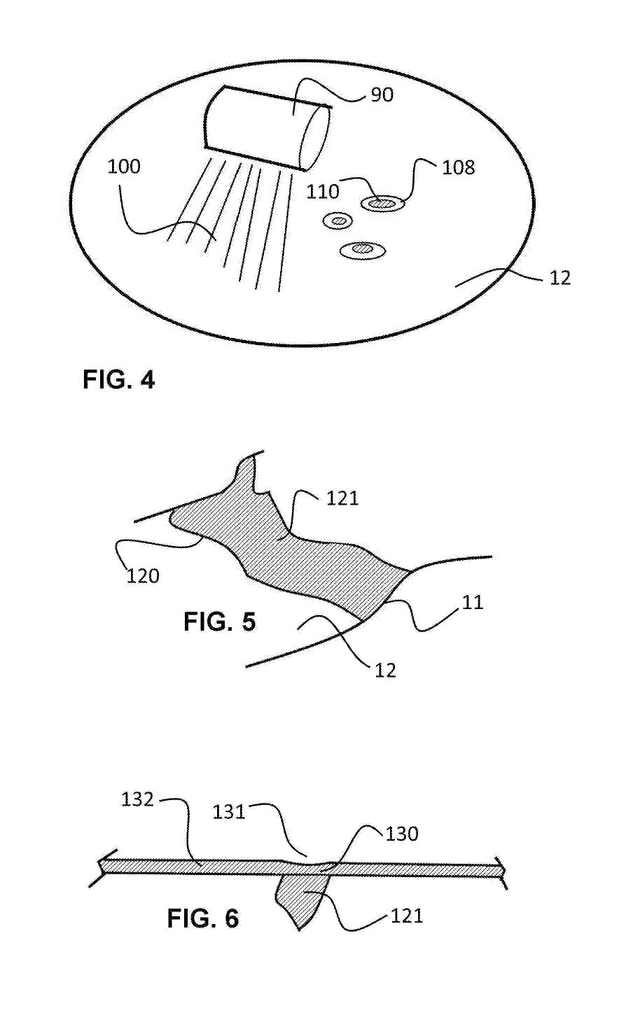

FIGS. 4 and 5 are each a perspective view of a small portion of the driveway 8 having the surface 12. In some cases, prior to formation of the indicia or pattern 40, the surface 12 is prepared. While other orders of steps may be used, it is found that in many cases an order is preferred. As seen in FIG. 4, in a first step, the surface 12 is leveled. This may be accomplished by scarifying the surface 12 using a tool 90 to produce a scarified area 100. Alternatively or additionally, patches 110 are filled into holes 108 in the surface 12. A next step comprises further preparing the surface 12 for an overlay of material if such is to be employed to cover both the original cracks and fissures as well as the imparted lines 44 forming indicia. Further preparation may include such things as application of cleaning liquids or primer.

Shown in FIG. 5 the cracks are filled and in order to fill some of the fissures, forms 120 may be placed in the cracks 11 to project slightly above are even with the top surface of the cracks 11 to mark their positions. Filler material 121 is applied to fill the volume in each crack 11 such may be cement, polymeric material, or other filler suitable to the task. Alternatively, a thin layer of overlay material 130 (FIG. 6) may be used that will leave a depression 131 over each crack 1.

Shown in FIG. 6 is a typical cross-sectional elevation of application of an overlay material 130 to the driveway. As seen in FIG. 6, an overlay material 130 is applied to form an overlay 132 of the underlying filled crack. The overlay 132 when applied, will cover the group 30 of fissures 10 such as in FIG. 2, and where lines 44 are imparted to the surface to form indicia, the overlay 132 may also cover them and the surface 12 will have a new appearance of the indicia formed by the lines 44 and the original group 30 of fissures and the patched and damaged look of the prior art is avoided.

The overlay material 130 also provides a vehicle for receiving color for the areas 46 (FIG. 3). The overlay material 130 comprises concrete or a concrete composition, or can comprise a polymeric surface material. Different overlay compositions may be used to accommodate climate conditions, expected load, and expected wear. A nominal range of thickness of the overlay 132 is 1/16 to ¼ inch. Different thicknesses may be required for other compositions. The overlay material preferably has a light color in order to facilitate application of other colors. The overlay material 130 is stained and sealed. Various concrete stains could be used. In the example of a driveway, sealing extends surface life. The appearance of decorative concrete is improved by enhancing the color and sheen.

High gloss sealers may be slippery. Acrylic sealers are generally preferred. The acrylic sealers may be blended with epoxies, polyurethane, or silicones to improve performance, durability, and water resistance. Other types of topical sealers for driveways are polyurethane, epoxies, and penetrating resins. Generally, epoxy or polyurethane sealers cost considerably more than acrylics and they tend to be higher build, and thus more slippery. They also don't allow for moisture vapor to move out of the concrete. It's important that sealers used on exterior concrete allow the passage of both air and moisture. Penetrating sealers are made of specialty resins such as silicones, siloxanes, and silanes that penetrate into the concrete and form a chemical barrier to water, oil, and other common contaminants.

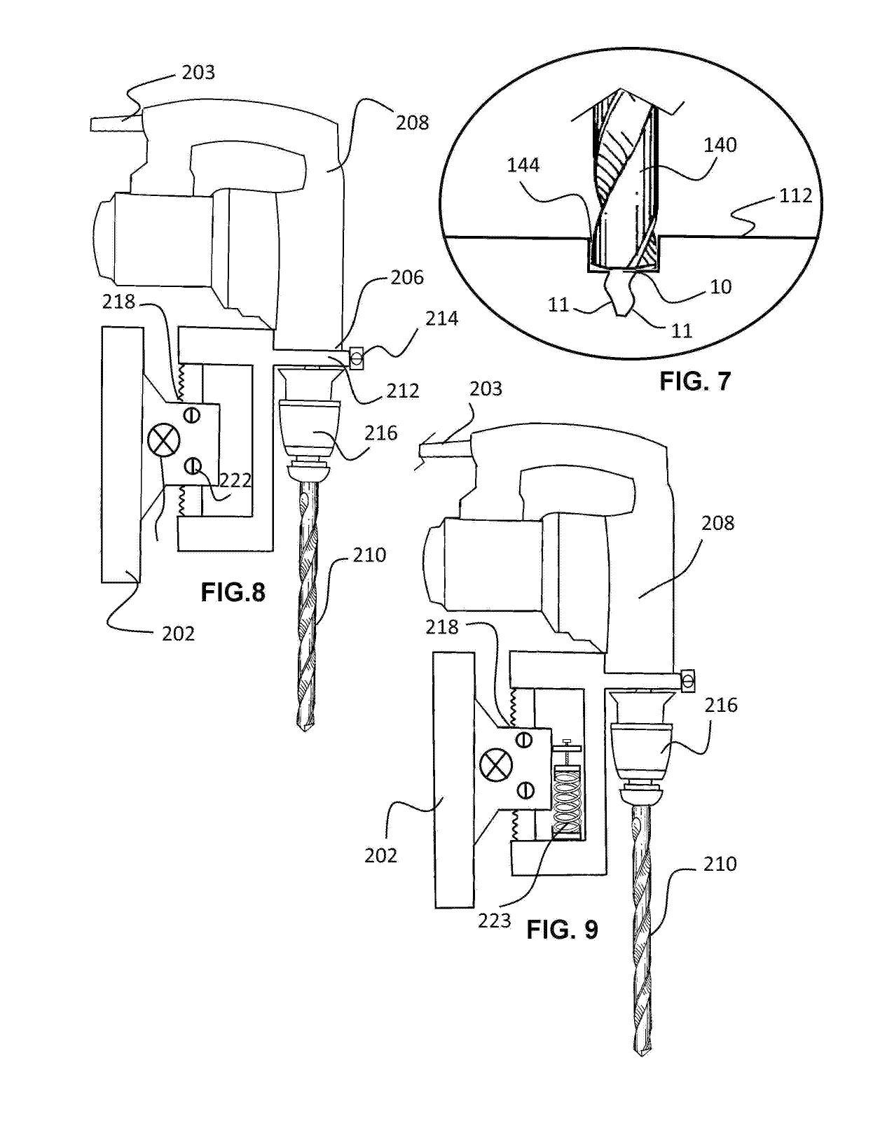

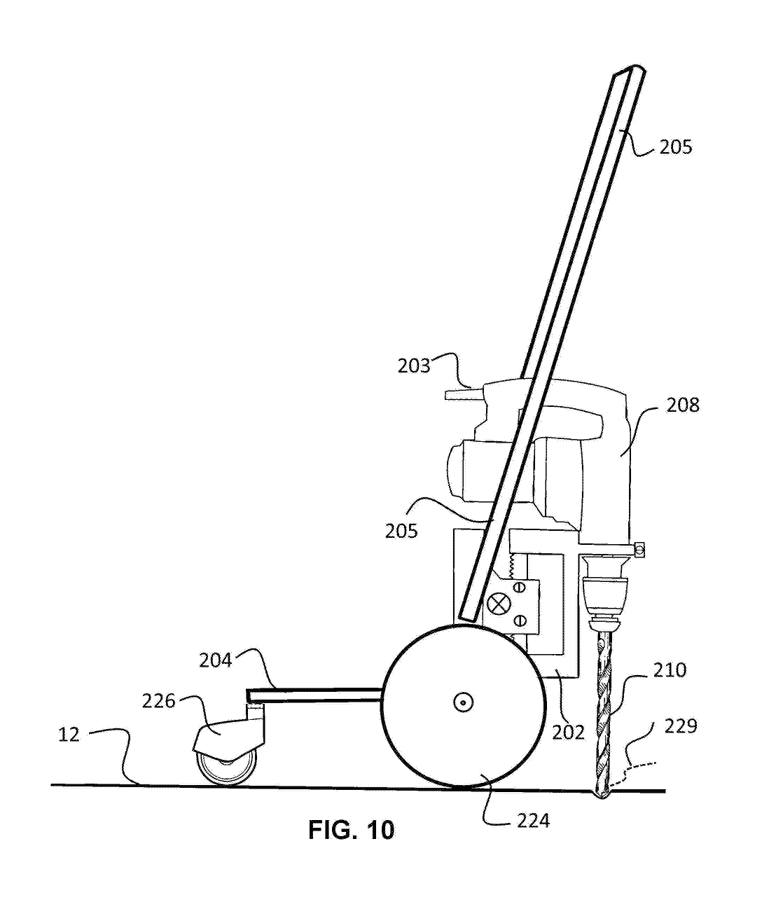

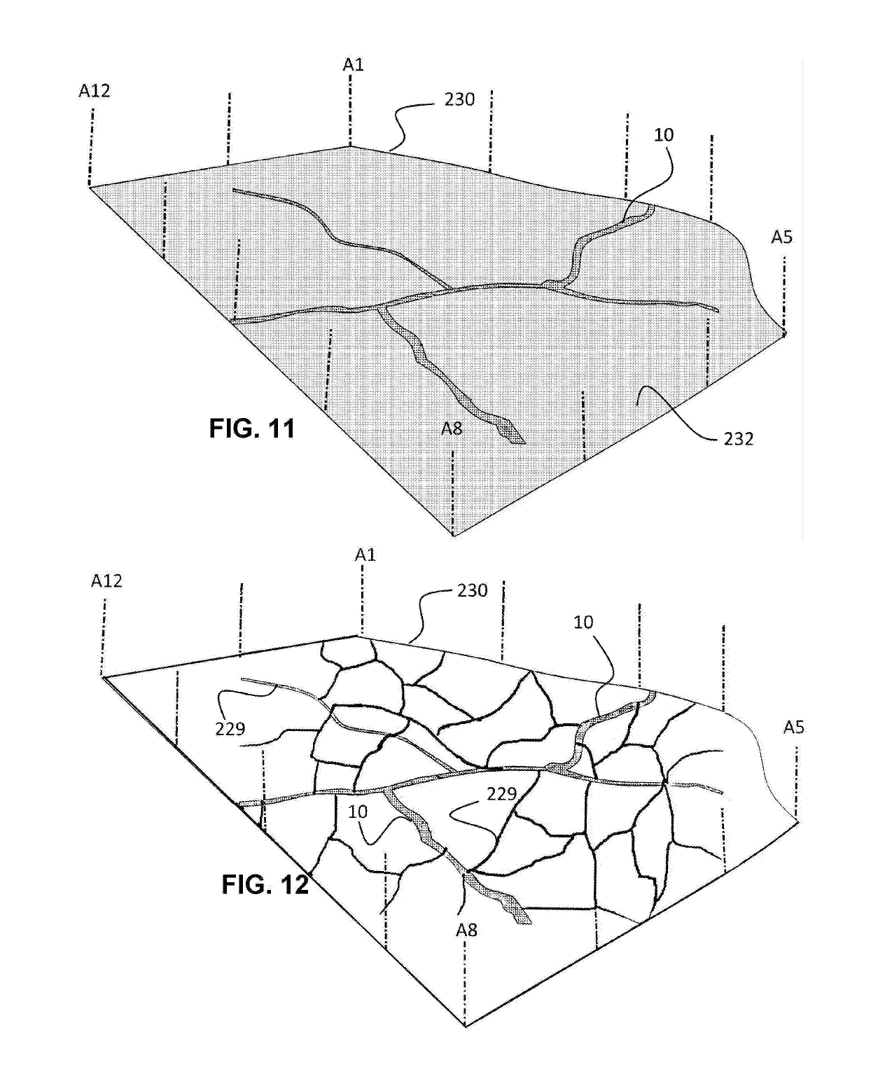

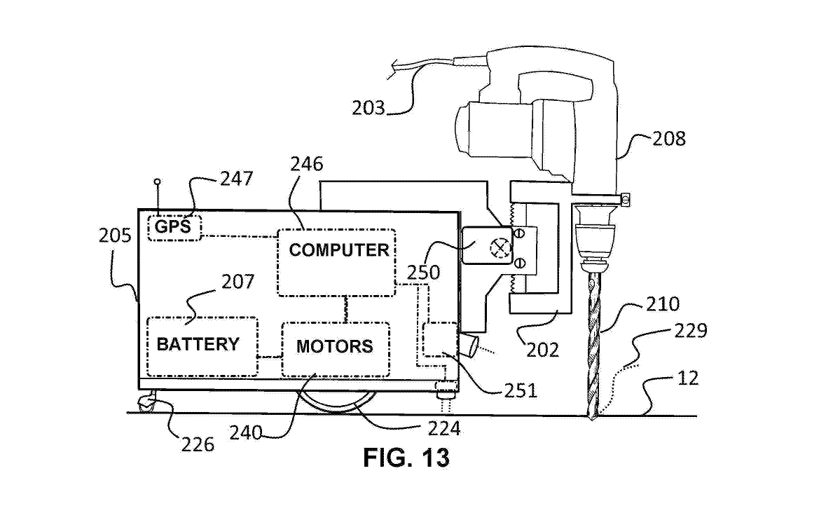

Shown in FIG. 7 is a cross-sectional elevation of formation of lines 44 or a channel above crack. An engraving tool, is employed to form the desired line 44 or recess such as a routing bit 140 is used to form a channel 144 above the fissure 10. Channels 144 are formed along existing cracks 1 first. Additional channels 144 to form the lines and the resulting indicia or pattern 40 (FIG. 3) are formed after the pattern 40 is formed using either the manual device of FIG. 10 or the automated device of FIG. 13. The channel 144 will later receive grout or fill material of choice. In this step existing cracks are routed first. The user may select a single engraving tool for routing. The tool may be selected from a group including drills, roto-hammers, impact drills, jack hammers, grinders, oscillating tools, vibrators, routers, saws, granite cutters, and concrete engraving tools.

Shown in FIG. 8 is a translating mount 202 which is engaged to a platform 204 which is adapted to roll upon the surface 12 being repaired or being imparted with indicia thereon through the use of the term engraving tool herein, as noted, is not limited to a bit 14 but can be any engraving tool adapted to the task at hand of forming channels 144 in the surface 12 upon which indicia is being placed.

As shown in FIG. 8, the mount 202 has an engagement position 206 which is adapted to connect with powered tool 208 which will move the engraving tool 201 to form the indicia into the surface 12 such as lines 144 or detents, or small recesses, which will form the indicia such as the pattern of lines appearing as a stone surface shown herein. The engagement position 206 shown herein, is a clamp 212 with compression fixing screw 214 which engages around the power tool 208 rearward of the chuck 216 which holds the engraving tool 210. This configuration of the mount 202 works well with hammer drills, drills, and similar power tools 208.

A rack and pinion 218 allows for translation of the distal end of the engraving tool 210 toward and away from the surface 12 to render deeper or shallower channels 144 or lines, and for lifting the distal end of the engraving tool 210 above the surface 12 to move it to another point to be channeled. A drive gear 220 allows for this translation by hand rotation or motorized rotation as in the mode of the system herein in FIG. 13. Locks 22 can be used to fix the position.

Shown in FIG. 9, is the same translating mount 202, but which also includes a biasing mechanism 223 which will bias the engraving tool 210 into the surface 12, but which will allow for the engraving tool 210 to retract if the bias is overcome such as would occur when an obstacle is encountered. The configuration of the mount 202 as in FIGS. 8 and 9, allows the user to employ their own power tool 20 and engage it with the mount, and thereby use the same tool for other purposes. The configuration of the engagement position 206 can be changed to adapted the engagement position 206 for operative engagements with other types of power tools 208 and such is anticipated within the scope of this patent. Also, in FIGS. 8 and 9 is depicted a control cable 203 for the powered tool 208 which can be employed to control the rotation and speed of the engraving tool 210 during use. This can be done by plugging the cord providing electric power into a receptacle which controls the electric power supplied to the tool 208 to provide such function. In the alternative, the control buttons (not shown but well known) on the tool 208 itself, can be employed.

Shown in FIG. 10 is a mode of the system herein, allowing for a user to pull the engraving tool 210 and place channels 144 or recesses or the like into the surface 12. As depicted the platform has a pair of wheels 224 located on a side of the platform 204 from which a handle 205 projects. A rotating wheel 226 is located on the end opposite the handle 205. This configuration has been found to be the easiest for a user to employ in forming the channels 144 in the surface 12 as it allows the user to view the engraving tool 210 from above while pulling the handle 205 during use, and to more easily turn the platform 204 during use. The aligned wheels 224 help maintain the engraving tool 210 in place during use as it was found to tool 210 would vary off course when the rotating wheel 226 used for steering was adjacent the tool 210.

Shown in FIG. 11, is an example of determining a pattern 40 formed of channels 144 which will be formed into the surface 12 to form indicia thereon which as shown in FIG. 12, will in this case, appear as a stone surface separated by grout. Of course other channels 144 can be formed to make the depicted indicia as virtually any image which can be rendered by forming of short and long channels 144 in the surface 12 and such is anticipated, especially with the automated mode of the system using the platform 205 of FIG. 13, which is self propelled and computer controlled.

As depicted in FIG. 11, the perimeter 230 of the surface 12 such as a driveway is determined, as are the existing fissures 10 which form the defect in the surface 12. This can be accomplished by drawing such, or using an overhead photo of the surface 12 and determining the perimeter 230 and fissure 10 location, or in other. In the automated mode using the platform 205 of FIG. 13, FIG. 11 can be a computer depiction on a computer display, and the perimeter 230 can be determined using GPS or other inputs to the computer along with an overhead photo of the surface 12. In this mode, points along the perimeter 230 such as a1, a5, a8, and a12, along with the shown positions in-between, can be measured by GPS coordinates, which can be communicated to the computer. Software running in electronic memory of the computer, will determine a shape of the surface 12 determined by the perimeter 230 which is determined by the input GPS coordinates for the points along the perimeter 230.

Using a photo, or other means for depicting the fissures 10 within the perimeter 230 and actual or electronic graph lines 232 positioned within the perimeter 230 in a virtual depiction of the surface 12, the positioning of channels 144 can be determined by the user, or by software adapted to employ the existing fissures 10 within the perimeter 230, and plot and depict positions on the surface 12 where channels 144 are to be placed to yield the desired indicia thereon, such as the depicted stone with grout indicia. FIG. 12 shows the system herein were software running in electronic memory on a computer, will use the input photo, or GPS points, or combinations thereof from FIG. 11, and determine a plan for positioning a guide 229 on the surface 12 to provide a pathway for the user to employ to use the tool to impart the channels.

Once the determined position of the channels 144 is calculated, the guide 229 may be formed and positioned upon the surface 12 for use as a pathway with the manual platform 204 as in FIG. 10, for the tool to impart the recesses and channels 144. The guide 229 may be positioned using chalk, paint, tape, markers, or other means. Thereafter the user working with the manual platform 204 will employ the guide positioned on the surface 12 as a pathway to impart the channels 144. Such positioning of a guide 229 may be determined using plot points from the graph 232 and measuring for example with a measuring tape, or the guide could be positioned upon the surface 12 projecting an image of a depiction of the location for the channels 144 upon the surface 12 from an overhead position, and marking the surface 12 with tape or chalk or markers as noted above. There are other means for marking a guide 229 on the surface 12 for the channel 144 location and such are anticipated.

Thereafter, with the guide 29 positioned on the surface 12, in the manual operation of the method herein, the user will use the platform 204 of FIG. 10, and pull the platform 204 with the handle 205. The user will steer the platform 204 to cause the engraving tool 210, to follow the guide 229 or pattern positioned on the surface 12 marking the path which will yield the channels 144 in the desired positions to form the indicia on the surface 12.

In a particularly preferred mode of the system herein, the mount 202 with the power tool 208 of choice engaged therewith, which has the engraving tool 210 of choice, is engaged with a self-propelled platform 205. As shown the self propelled platform 205 has wheels 224 which are operatively engaged with electric motors 240 which will propel the platform 205 forward and rearward and in turns required, to follow an electronic guide 229 held in memory of a computing device 246. The positioning of the engraving tool 210 upon the surface 12 to impart the channels 144 desired to form the indicia is handled by the computer 246 controlling the motors 240 to move the engraving tool 210 upon the surface 12 along the guide held in electronic memory.

The self propelled platform 205 will start from a known position upon the surface 12 which may either be input to the computer 246, or determined using an electronic location sensor such as a GPS receiver 247 communicating the terrestrial position of the platform 205 to the computer 246 which will use that information to drive the platform 205 using the motor or motors 240 on the surface 12. This mode of the method and device herein, like the others will allow the user to mount an existing power tool 208 on the mount 202. As shown in FIG. 13, the mount 202 may have an electric motor 250 rotating the drive gear 220 of the rack and pinion 218 to cause the distal end of the tool 210 to move deeper and shallower into the surface 12, and to raise above the surface 12 when changing positions. This electronic driven rack and pinion 218 allows for much faster translational positioning of the tool 210, and for the formation of highly detailed indicia on the surface 12. This is because the channels 144 and their positioning, their length, and their depth, and even their width can be controlled with extreme accuracy. Indeed the tool 210 in this mode could be driven to impart indicia into the surface 12 not only of for example stone with grout as noted herein, but the indicia could also be a picture of a dog or pet, or a sunset, or virtually any indicia which can be take from a photo or drawing, and placed into the surface 12 using the electronic guide and computer control of the platform 205.

It should be noted that while the method and apparatus herein is described for imparting channels 244 or recesses into a surface 12 which is generally horizontal, it could be employed to impart indicia into vertically disposed surfaces using either a platform 204 or 205 which is supported to move in a vertical orientation, or, by positioning an moveable arm (not shown) in between the platform 204 or 205 and the mount 202. Where the computerized system is employed similar to that of FIG. 13, a robotic arm (not shown) could be engaged between the self propelled platform 205 and the mount 202, and thereby move the mount 202 vertically while controlling the translation of the tool 210. In this fashion indicia can be imparted to vertically disposed stone and cementitious surfaces.

A control cable assembly 240 extends from the handle 226 to the channel tool 200 to allow a user to control functions of the channel tool 200. The channel tool 200 is secured to a mounting bracket 246 mounted on the cart 220. The mounting bracket 246 comprises a height adjusting assembly slide assembly 248. The slide assembly 248 allows for selection of the height of the cutting element 214. The slide assembly 246 may include vertically displaced detents or a ratchet, for example. A spring-loaded or totally manual height adjustment may be provided. Height may also be adjusted by adjustable height wheel mounting. In this manner, the cutting element 214 may be disengaged from the surface 12 or lowered to produce a selected depth of the channel 144. The control cable assembly 240 is operated by the user to control the slide assembly 248.

The present subject matter is not limited to the specific methods stated above. Other options for creating an appearance of authentic set-stone on a masonry or concrete may use selected subsets of the steps described above. Preference and budget will dictate which steps should be used. Areas of high visibility will be most appealing and authentic if more steps are performed.
In a more rigorous method the user will:

1. Grind or scarify surface where necessary for evenness and safety.

2. Create channel in existing cracks, if applicable; if not, then create channels that will serve as control joints to future cracking.

3. Place stop channels, cardboard furring strips, foam (or other material that can be removed easily after overlay and texturing procedure).

4. Prepare surface using recommended materials for optimal performance of overlay material.

5. Apply overlay and stamp or texture which may be tinted with coloring.

6. Apply colors to desired result.

7. Apply sealer to protect color work from being clouded by grout material. This makes for easier cleanup after grouting.

8. Outline desired patterns to be turned into channels. This can be accomplished by scoring lines, chalking, taping, or other. An experienced artist can perform this task without using outlines and can achieve a desired appearance.

9. Use power tool to create complimentary additional channels that will be grouted.

10. Apply grout and use typical grout-cleanup methods commonly used.

11. After grout is cured, another coat of sealer is applied.
In a more basic method than those described above, the user will:

1. Grind or scarify surface only if necessary for evenness and safety.

2. Apply color to surface for desired result.

3. Apply sealer to protect color work from being clouded by grout material. This makes for easier cleanup after grouting.

4. Instead of creating deep channels with invention, use at shallow depth to create the appearance of grout rather than actually applying grout. This does not yield as authentic a result as actually applying grout does, but allows a ‘quick-fix’ and saves a lot of work. Further, when rendering indicia into the surface which is a photo or drawing or the like, the channels may simply be small dot-like recesses formed into the surface which when viewed from afar, appear as the intended photo image or drawing.

Finally, in a simple but effective method of the system herein,

a) the position of the fissures will be determined upon the surface;

b) the placement positions for channels is determined which in combination with the fissures, will form the desired image or indicia into the surface;

c) a guide determined using the placement position for channels and imparted to the surface;

d) the guide is employed by a user to impart the channels in the placement positions on the surface using a powered tool to form the channels in the placement positions;

e) the original fissures may be filled with filler material.

In employing the guide to impart the channels to the surface, the user may use a wheeled platform to pull the powdered tool, or if a robotic platform is employed, a computer navigation system on the platform will drive and steer the platform, to form the channels using the guide which is stored in electronic memory.

While all of the fundamental characteristics and features of the surface repair and remediation system herein have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that upon reading this disclosure and becoming aware of the disclosed novel and useful device and system herein disclosed, that various substitutions, modifications, and variations may occur to and be made by those skilled in the art, without departing from the spirit or scope of the invention. Consequently, all such modifications and variations and substitutions, as would occur to those skilled in the art are considered included within the scope of the invention as defined by the following claims.

What is claimed is:

1. A method for restoration of concrete and cementitious surfaces, comprising:
determining the position of fissures in a concrete surface within a perimeter edge defining a surface area;
determining placement positions for channels in said concrete surface to form indicia therein in combination with said fissures;
using said placement positions to determine a guide for positioning of said channels in said concrete surface; and
positioning said guide upon said concrete surface to define a pathway for employment of a tool to form said channels in said placement positions upon said concrete surface.

2. The method for restoration of concrete and cementitious surfaces of claim 1, additionally comprising:
positioning said guide upon said concrete surface by placing visible lines upon said concrete surface.

3. The method for restoration of concrete and cementitious surfaces of claim 1, additionally comprising:
filling said fissures with filler material to a point where a top surface of said filler material is at an elevation slightly below an elevation of said concrete surface;
forming said channels into said concrete surface; and
affixing an overlay surface to cover both said top surface of said filler material and said channels whereby said channels in combination with said top surface of said fissures have an appearance of grout lines surrounding areas of said concrete surface.

4. The method for restoration of concrete and cementitious surfaces of claim 2, additionally comprising:
filling said fissures with filler material to a point where a top surface of said filler material is at an elevation slightly below an elevation of said concrete surface;
forming said channels into said concrete surface; and
affixing an overlay surface to cover both said top surface of said filler material and said channels, whereby said channels in combination with said top surface of said fissures have an appearance of grout lines surrounding areas of said concrete surface.

5. The method for restoration of concrete and cementitious surfaces of claim 1, additionally comprising:
forming a digital image of said position of fissures in a concrete surface within said perimeter edge, and storing said digital image in electronic memory of a computer;
employing software running in said electronic memory which is adapted for determining said placement positions for said channels in said concrete surface to form said indicia therein, in combination with said fissures;
employing software running in said electronic memory to determine said guide for positioning of said channels in said concrete surface, based on said placement positions;
communicating said guide to electronic memory of a computing device on a motorized platform operatively engaged with said tool; and
employing software running on said computing device on said motorized platform to use said guide for positioning of said channels, to drive said motorized platform upon said concrete surface and form said channels with said tool.
